(19) United States
(12) Patent Application Publication
(10) Pub. No.: US 2009/0320522 A1
(43) Pub. Date: Dec. 31, 2009

(54) PROCESS FOR PRODUCING OPTICAL GLASS DEVICE

(75) Inventor: Sunao Miyazaki, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY LIMITED, Tokyo (JP)

(21) Appl. No.: 12/555,461

(22) Filed: Sep. 8, 2009

Related U.S. Application Data
(63) Continuation of application No. PCT/JP2008/054023, filed on Mar. 6, 2008.

(30) Foreign Application Priority Data
Mar. 7, 2007 (JP) 2007-057498

(51) Int. Cl. C03B 11/00

(52) U.S. Cl. 65/29.12

(57) ABSTRACT

It is an object of present invention to select the most suitable composition and molding condition for obtaining a glass having a desired refractive index by press molding without any annealing treatment, for a short period of time so as to produce efficiently the glass. In the invention, a glass composition showing a target refractive index in the case where annealing is conducted is regarded as a basic composition, a component ratio of the basic composition is changed with defining as a predetermined range a range where values of the target refractive index+(100 to 850)×10⁻⁵ are upper and lower limits, a plurality of glass compositions whose estimated refractive index values estimated based on a variation in composition from the above basic composition are regularly changed within the predetermined range are provided as candidate compositions, glass molded articles having the above candidate compositions are prepared under a predetermined condition and the refractive indices thereof are measured, and the candidate composition of the glass molded article having a measured refractive index value coincident with or closest to the target refractive index is determined as an implementation composition. In the case where the measured refractive index is not coincident therewith, the molding condition is regularly changed, glass molded articles having the implementation composition are obtained under the above plurality of molding conditions and the refractive indices thereof are measured, and a molding condition of the glass molded article having a refractive index coincident with or closest to the target refractive index is determined as an implementation condition.

### TECHNICAL FIELD

The present invention relates to a method for producing an optical glass element, which produces an optical glass element such as a lens by press molding. More specifically, it relates to a method for producing an optical glass element with which various conditions for obtaining an optical glass element having a desired refractive index by press molding with omitting an annealing treatment can be promptly determined and the production can be carried out efficiently.

### BACKGROUND ART

Recently, attention has been focused on a direct press molding method wherein an optical glass element such as a glass lens is press-molded and the molded surface can be used as it is without polishing or the like. Owing to rapid decrease in temperature after pressing at molding temperature, the optical element obtained by the direct press molding method has a refractive index value somewhat lower than the refractive index of the optical glass before molding (the catalog value). Therefore, the lens designed based on the catalog value cannot be used as it is, and it becomes necessary to conduct an annealing treatment to restore the refractive index to the catalog value or vicinity of the catalog value. Namely, for producing a lens with omitting the anneal treatment, it is necessary to investigate a refractive index after molding (an annealing-less refractive index) and design the lens based on the value.

Moreover, in the case where a lens which has been hitherto produced by a molding method with the annealing treatment is produced with switching the method to a molding method without an annealing treatment, in order to cope therewith out changing the design, it is necessary to change the lens composition to a glass composition which shows a refractive index, in a state without the annealing treatment, equal to the refractive index of the conventional lens which has been subjected to annealing. For the purpose, the composition of glass materials should be changed. On the other hand, in the field of optical design, there are various glasses that designers have used as regular materials for designing optical glass products. In order to efficiently advance the design, it is desired that the designers can utilize the catalog values of the regular glasses so that they can design the products with familiar numerical values. However, those values are determined on the glasses subjected to the annealing treatment, it is difficult to directly utilize the values at the time when the annealing treatment is omitted.

Under such a situation, in the method for molding an optical glass element without the annealing treatment proposed in Patent Document 1, press molding is conducted using a glass material having a refractive index value obtained by subtracting a variation in refractive index, which is generated on the glass material by press molding, from the value of refractive index required for the optical glass element after molding. Moreover, Patent Document 2, which proposes a method similar to the method in Patent Document 1, further describes press molding under conditions which substantially eliminate thermal hysteresis of the glass material.

Patent Document 1: Japanese Patent No. 3196952

Patent Document 2: Japanese Patent No. 3801136

### DISCLOSURE OF THE INVENTION

### Problems to be Solved by the Invention

In the aforementioned Patent Documents 1 and 2, after a glass composition having a refractive index value obtained by subtracting a variation in refractive index generated by press molding from the target refractive index value is searched, a measured refractive index value obtained by actually conducting press molding is compared with the target value, the composition of the glass material is changed in order to diminish the difference with the target value, and the preparation of the glass material, press molding, and the measurement of refractive index are repeated.

However, since the variation in refractive index by press molding varies when the glass composition is changed, it is necessary to repeat the composition change, press molding, and the measurement many times until the most suitable glass composition is attained, so that it is not easy to determine the most suitable glass composition within a short period of time. Moreover, when a material whose thermal hysteresis is not clear is first used as a glass sample for determining the variation in refractive index, validity of the determined variation becomes lower, accuracy in selection of the glass composition is lowered, and thus working efficiency is decreased, so that it is necessary to pay attention to the adoption of the sample.

It is an object of the present invention to provide a method for producing an optical glass element, which enables efficient production of an optical glass element having a desired refractive index by press molding without any annealing treatment.

It is also an object of the invention to provide a method for producing an optical glass element, which can determine the most suitable glass composition and molding condition for obtaining an optical glass element having a desired refractive index in a convenient manner and for a short period of time and can efficiently obtain the optical glass element by press molding without any annealing treatment.

### Means for Solving the Problems

For achieving the above objects, according to one embodiment of the invention, the gist of the method for producing the optical glass element is a method for producing an optical glass element showing a desired refractive index by press molding without any annealing treatment, which comprises a step of regarding the desired refractive index as a target refractive index, determining as a basic composition a glass composition showing the target refractive index when subjected to an annealing treatment after press molding, changing a component ratio of the basic composition with defining as a predetermined range a range where values of the target refractive index+(100 to 850)×10⁻⁵ are upper and lower limits, and providing as candidate compositions a plurality of glass compositions whose estimated refractive index values estimated based on a variation in composition from the basic composition are regularly changed within the predetermined range,

a step of preparing glasses having the above candidate compositions and subjecting them to press molding under a predetermined molding condition to obtain glass molded articles having the above candidate compositions,

a step of measuring the refractive indices of the glass molded articles having the above candidate compositions and determining the candidate composition of the glass molded article having a measured refractive index value coincident with or closest to the above target refractive index as an implementation composition,

a step of, in the case where the measured refractive index value of the glass molded article having the above implementation composition is coincident with the above target refractive index, determining the above predetermined molding condition as an implementation molding condition; in the case where the measured refractive index value of the glass molded article having the above implementation composition is not coincident with the above target refractive index, subjecting the glass having the above implementation composition to press molding under each of a plurality of molding conditions regularly changed from the above predetermined molding condition to obtain glass molded articles having an implementation composition under the above plurality of molding conditions, measuring the refractive indices of the glass molded articles, and determining a molding condition of the glass molded article having a measured refractive index value coincident with or closest to the above target refractive index as an implementation condition, and

a step of preparing a glass having the above implementation composition and subjecting it to press molding under the above implementation molding condition to obtain a glass molded article.

### ADVANTAGE OF THE INVENTION

According to the present invention, since the most suitable glass composition and molding condition for producing an optical glass element having a desired refractive index by press molding without any annealing treatment can be efficiently determined and the production can be carried out promptly, there is provided a method for producing an optical glass element which responds quickly to a design change, which enables efficient production of an optical glass element having a desired refractive index directly usable after press molding and which facilitates small quantity production of a wide variety of products.

### BRIEF DESCRIPTION OF THE DRAWINGS

FIG. 1 is a schematic view illustrating a cross-section of a mold to be used in the implementation of the invention.

FIG. 2 is a schematic view illustrating a cross-section of a press molding apparatus to be used in the implementation of the invention.

### DESCRIPTION OF REFERENCE NUMERALS

1: Cemented carbide part of lower mold, 2: Coating film, 10: Press molding apparatus, 11: Upper mold, 12: Lower mold, 13: Chamber, 14, 15: Heater block, 16: Hydraulic cylinder, 17: Lower shaft, 18: Article to be molded, 19: Upper shaft.

### Best Mode for Carrying Out the Invention

Since a variation in refractive index of an optical glass element obtained by press molding which changes depending on the presence or absence of an annealing treatment varies depending on the glass composition, even when the variation in refractive index is determined in the glass composition showing a target refractive index in a state where it is subjected to the annealing treatment, the degree is not coincident with the variation in a target glass composition. Therefore, even when a glass composition is selected based on the variation, composition change, preparation, press molding, and measurement of refractive index should be repeated. Namely, it is not an efficient method to select a single glass composition based on the aforementioned variation in refractive index.

It is obvious that the aforementioned variation in refractive index does not vary unlimitedly, although it varies depending on the glass composition, and falls within a certain range. Therefore, when glass samples are prepared at a time within a composition range corresponding to the range where the variation in refractive index is estimated and the refractive indices after press molding are measured all at once, the most suitable glass composition can be roughly understood. On this occasion, when the compositions of the glass samples are allocated so that the refractive indices of the glass samples after press molding vary at intervals of almost tolerance of the refractive index of the optical glass, a difference between the most suitable composition selected from the samples and the true most suitable composition falls within the tolerance range. Since the physical properties of glass, such as refractive index, can be estimated from the variation in composition based on the additivity relationship of glass with a certain degree of probability when the presumption is performed within a narrow range, the compositions can be allocated from a basic composition with setting a variation in composition so that estimated refractive index values change at intervals of almost tolerance, while the composition whose refractive index is known being regarded as the basic composition. Thus, using the compositions, the aforementioned samples can be prepared. Moreover, in the case where the most suitable composition selected from the samples is actually different from the true most suitable composition, such a degree of the difference can be easily fine adjusted by molding conditions such as a cooling rate after press molding.

Accordingly, in the invention, glass samples are prepared within a certain degree of compositional range all at once and the refractive indices after press molding are measured to determine the most suitable composition for complementation at a time. Also, a difference in refractive index induced by a minute difference in composition is diminished by fine adjustment through change and control of a molding condition. Then, by subjecting the glass prepared in accordance with the determined composition to press molding and cooling according to the molding condition fine adjusted through the change and control, a glass molded article showing a target refractive index is produced and thus any annealing treatment after press molding becomes unnecessary.

The following will describe the method for producing an optical glass element according to the invention. A glass molded article showing a target refractive index can be produced without any annealing treatment after press molding in accordance with the following steps 1 to 5.

Step 1: a glass composition showing the target refractive index when subjected to an annealing treatment after press molding is set to a basic composition, a component ratio of the basic composition is changed, and a plurality of glass compositions are provided whose estimated refractive index values estimated based on a variation in composition from the above basic composition are regularly changed within the predetermined range, the compositions being set to candidate compositions.

Step 2: Glasses having the candidate compositions are prepared and subjected to press molding under a predetermined molding condition to obtain glass molded articles having the candidate compositions.

Step 3: Refractive indices of the glass molded articles having the candidate compositions are measured and the candidate composition of the glass molded article having a measured refractive index value coincident with or closest to the above target refractive index is determined as an implementation composition.

Step 4: In the case where the measured refractive index of the glass molded article having the above implementation composition is coincident with the above target refractive index, the above predetermined molding condition is determined as an implementation condition. In the case where the measured refractive index of the glass molded article having the above implementation composition is not coincident with the above target refractive index, the molding condition is changed from the predetermined molding condition and a more appropriate molding condition is determined as an implementation condition.

Step 5: A glass having the above implementation composition determined in the above step is prepared and subjected to press molding in accordance with the implementation condition determined in the above step to obtain a glass molded article.

Through the above steps 1 to 4, the most suitable implementation composition and implementation molding conditions are determined. By press molding of a glass using them in step 5, it becomes possible to produce an optical glass element actually showing the target refractive index. The following will describe each of the above steps 1 to 5 in detail.

### <Step 1: Setting of Candidate Compositions>

First, as a basic composition, a glass composition showing the target refractive index when subjected to an annealing treatment after press molding is set. In order to produce a glass molded article without any annealing treatment which has been hitherto produced with the annealing treatment, the designed value of the refractive index of the optical glass element, i.e., the refractive index of the optical glass element subjected to the annealing treatment is regarded as a target refractive index (n) and the glass composition is directly determined as a basic composition. Moreover, in the case of producing a glass molded article which has not hitherto produced, utilizing catalog values of various glasses that the designers have hitherto used as regular materials in the design of optical glass products or refractive index data which have been already obtained in the composition development of glasses, a glass having a target refractive index or closest value thereto is selected and the composition may be determined as a basic composition.

Next, the component ratio of the basic composition is changed and a plurality of glass compositions whose estimated refractive index values are regularly changed within the predetermined range are provided and the compositions are set as candidate compositions.

The range of the estimated refractive index values to be defined for providing candidate compositions, i.e., the above predetermined range is a range where values of the target refractive index+(100 to 850)×10⁻⁵ are upper and lower limits. Since the variation in refractive index induced by molding varies depending on the glass composition, the predetermined range can be suitably changed according to the basic composition. Moreover, with regard to the composition system wherein the correlation between the composition and the refractive index is precisely known, the range which is necessary to measure can be limited as compared with an unknown composition system, so that the range may be suitably specified and set from the above range.

A plurality of glass compositions wherein the component ratio of the basic composition is changed and the estimated refractive index values are regularly changed within the above predetermined range is set so that the variation in composition from the basic composition is changed at constant intervals and the refractive index values are estimated so that the refractive index changes in a ratio corresponding to the variation in composition (additivity relationship). Therefore, the estimated refractive index values estimated based on the variation in composition with regard to a large number of compositions also have a mutual interval of a constant value. The variation in composition is set so that the interval is almost tolerance of the glass or less. Therefore, the variation in composition is set so that the interval of the measured refractive index values is about 50×10⁻⁵ or less. Such a variation in composition can be provided by a replacement amount at which one component is replaced with another component among two or more components constituting the above basic composition and the above estimated refractive index value is calculated using the basic refractive index and the replacement amount based on additivity relationship of glass. In this connection, the variation in composition can be adjusted with two or more components but, for simplification, the case of two components is described in the following.

Specifically, in the glass composition wherein the constitutional components are the same but the contents are different, e.g., the glass composition containing the component A and B as constitutional components, in the case where refractive indices nₚ and n_{q} are obtained in the two glass compositions Cp and Cq wherein only the contents of the components A and B are different and the compositional ratios of the other constitutional components are the same (i.e., one of the components A and B is replaced with the other one), a ratio of the difference in refractive index (nₚ−n_{q}) to the difference (aₚ−a_{q}) [or (bₚ−b_{q})] of the content of the component A (or B), i.e., a change ratio, is determined from the contents aₚ and a_{q} (or bₚ and b_{q}) of the component A (or B). Using the change ratio (nₚ−n_{q})/(aₚ−a_{q}) [or (nₚ−n_{q})/(bₚ−b_{q})], an estimated refractive index value in a glass composition wherein the content of the components A and B are changed between Cp and Cp can be determined by linearly allocating the refractive indices toward the compositions. Since the aforementioned change ratio of the refractive index is a necessary data at the development of the glass composition, some glass compositions have existing data. Thus, utilizing the existing date or the change ratio of the refractive index obtained by measurement, glass compositions are allocated by changing them from the basic composition so that the estimated refractive index values are changed at predetermined intervals and thus data of the glass compositions and the estimated values are prepared. On this occasion, when the glass compositions are allocated so that the interval of the estimated refractive index values to be prepared is 100×10⁻⁵ or less, preferably 50×10⁻⁵, the interval of the refractive indices of the glasses actually prepared and subjected to press molding as candidate compositions is also about 50×10⁻⁵ and hence a glass composition having a refractive index within the range of the target refractive index n±50×10⁻⁵ after molding is necessarily present in the candidate compositions. For example, the glass compositions are allocated in the range of glass compositions where the refractive indices are changed from the refractive index in the basic composition by 100×10⁻⁵ to 850×10⁻⁵ so that the interval of the refractive indices is 50×10⁻⁵ (100×10⁻⁵, 150×10⁻⁵, 200×10⁻⁵, . . . , 850×10⁻⁵). The applicable range of such presumption of the refractive index utilizing the additivity relationship of glass is limited to a narrow range but the presumption is well applicable to increase or decrease of about 850×10⁻⁵ as in the invention.

Accordingly, when the glass compositions are allocated as mentioned above, a difference of the measured refractive index value of a glass molded article having a composition selected from the candidate compositions from the target refractive index falls within the range of tolerance. In the invention, since further fine adjustment of the refractive index is possible by changing a molding condition whose detail will be mentioned below, up to a value of about 100×10⁻⁵ is allowable as the interval of the estimated refractive index values.

Thus, the component ratio of the basic composition is changed, and a plurality of glass compositions whose estimated refractive index values fall within the above predetermined range are provided, the compositions being set as candidate compositions.

### <Step 2: Preparation of Glasses Having Candidate Compositions and Press Molding>

With regard to all the candidate compositions, glass materials are blended to prepare glasses, which are subjected to press molding under a predetermined molding condition to obtain glass molded articles having candidate compositions.

In the preparation of the glass material, in accordance with the standard method, glass raw materials may be mechanically blended based on the candidate composition to adjust the composition, followed by melting under heating, vitrification, defoaming, and homogenization. The preparation of glasses having a plurality of candidate compositions can be completed in convenient manner and within a short period of time when an assembly-line operation or combinatorial procedure and apparatus are used. In this connection, in the invention, it is entirely unnecessary to measure the refractive index of the prepared glass material before press molding.

The prepared glass material having a candidate composition is subjected to press molding. The press molding is conducted by heating the material to a temperature where the viscosity of the glass having the basic composition becomes a predetermined value (usually about 10⁻⁹ dPa·s) and subsequent cooling (rapid cooling or gradual cooling, presence or absence of temperature maintenance) becomes a molding condition which dominates the refractive index of the glass after molding.

The viscosity hardly varies within the range of change in composition in the invention but the viscosity in the case of the basic composition is adopted as a standard. Usually, the cooling rate after molding can be changed in the range of about 5 to 200° C./minute and a constant cooling rate among them is adopted.

The molding condition of this step can be arbitrarily set and it is preferable to set a molding condition which is most easily carried out at the time when a product is actually molded. The reason is easy adoption of the molding condition that is most easily implemented. In the case where it is found that a composition having a refractive index of the glass molded article coincident with the target refractive index is contained in the candidate compositions in step 4, the predetermined molding condition directly becomes a molding condition for implementation. Therefore, when the molding condition that is most easily implemented is set as a first molding condition, the molding condition that is most easily implemented becomes the most suitable molding condition. Accordingly, it is preferable that, as a predetermined molding condition, a cooling rate after press molding is set within the range of 50 to 120° C./minute and cooling is conducted until around the glass transition temperature Tg at the cooling temperature. In this connection, since the press molding in the step is conducted for determining the refractive index of the glass after molding, the molded shape may be any shape so far as an effective measured value is obtained and, even when the shape is different from the shape and size of the product, such as a lens, to be actually produced, the refractive index after molding is hardly affected so far as the molding conditions are the same.

### <Step 3: Determination of Implementation Composition>

Refractive indices of the glass molded articles having the candidate compositions are measured and the candidate composition of the glass molded article having a measured refractive index value coincident with or closest to the above target refractive index is extracted and determined as an implementation composition.

Specifically, the glass molded articles having the candidate compositions obtained from the glasses after molding without any annealing treatment are subjected to prism processing and refractive indices are measured to obtain measured refractive indices in the candidate compositions. For precise measurement of the refractive index, the prism processing is necessary. For example, in accordance with the standard method, the glass after molding is ground into a predetermined prism shape (90° prism) by means of a grinding apparatus or the like and the refractive index of the prism is measured on a Pulfrich-type refractometer.

Since a plurality of samples can be subjected to prism processing all at once, a method of treating a plurality of samples at a time as in the case of the invention is more advantageous than a method of individual treatment. Moreover, in the measurement of the refractive index, since a time consuming process is mainly a process of warming-up for stabilizing a light source for measurement, the increase in number of samples to be measured is not so large burden of time and this fact is advantageous for the method of treating a plurality of samples at a time as in the case of the invention.

The measured refractive index values of the above glass molded articles are compared with the target refractive index and the glass composition of a glass molded article having a refractive index coincident with or closest to the target refractive index is determined as an implementation composition. The implementation composition is not necessarily limited to only one composition and two or more compositions may be selected in consideration of error, difference by the composition, and the like depending on the situation. The number of the implementation compositions can be determined within the range which is not a burden to the operations in step 4 and the following step and the determination of one to three compositions is preferable.

The difference between the refractive index of the glass molded article having the implementation composition and the target refractive index is necessarily a value capable of being diminished by changing a molding condition. With regard to the molding condition, since the refractive index after molding can be fine adjusted by a unit of about 5×10⁻⁵ to 15×10⁻⁵ when the cooling rate after press molding is changed at intervals of about 5 to 10° C./minute, a composition is appropriate as an implementation composition when the difference in refractive index falls within the range of about 30×10⁻⁵ or less, preferably 15×10⁻⁵ or less. With regard to this point, the constitution by a set of compositions where the interval of the estimated refractive index values is about 50×10⁻⁵ as mentioned above facilitates arrival at the glass molded article having the target refractive index by changing the molding condition. The fine adjustment of the refractive index by changing the molding condition is possible in both directions of increase and decrease of the refractive index. However, since it is easier to conduct the fine adjustment for decrease, it is preferable to select the closest one within the range where the measured refractive index values are larger than the target refractive index.

Incidentally, in the selection of the implementation composition, depending on the frequency of preparation experience, the selection may be conducted with weighing the difference in refractive index every basic composition.

### <Step 4: Determination of Implementation Molding Conditions>

In the case where the measured refractive index value of the glass molded article having the implementation composition is coincident with the target refractive index, the above predetermined molding condition is determined as an implementation molding condition. However, even in the case where a composition having a measured refractive index coincident with the target refractive index is present, it is not excluded that the following molding condition is changed for the candidate composition having a measured value close to the target refractive index and the results are compared. Such comparison is effective for securing alternatives.

In the case where the measured refractive index of the glass molded article having the implementation composition is not coincident with the target refractive index, the molding condition is changed from the predetermined molding condition and a more appropriate molding condition is determined as an implementation condition.

In the change of the molding condition, first, a plurality of molding conditions to be regularly changed from the aforementioned predetermined molding condition are set. Under each of these molding conditions, the glass having the aforementioned implementation composition is subjected to press molding to obtain a glass molded article having the implementation composition under each of a plurality of the molding conditions. The refractive index of the glass molded article is measured and the molding condition of the glass molded article having a measured refractive index value coincident with or closest to the above target refractive index is determined as an implementation condition.

As the molding conditions to be changed, the cooling rate after molding is preferable since it is most easy to handle and accuracy is high. In the case where the cooling rate is changed, regular change in molding condition is possible through changing and allocating the cooling rates at constant change intervals and a plurality of cooling rates thus changed are employed as a plurality of molding conditions to be changed. When the interval of the cooling rate is set to about 20° C./minute or less, preferably about 5 to 10° C./minute, the refractive index after molding can be suitably fine adjusted within the range of the target refractive index n±50×10⁻⁵ When the cooling rate is increased, the refractive index decreases, while when the cooling rate is decreased, the refractive index increases. The molding condition can be suitably selected by allocating the cooling rates within the rate range of about 5 to 200° C./minute and allocating about five conditions.

Under a plurality of the molding conditions changed as mentioned above, glass molded articles are produced using a glass having the implementation composition. In the press molding in this step, it is desirable to mold the glass into a shape the same as that of an actual optical element product in order to further enhance accuracy. A plurality of the glass molded articles different in molding condition after press molding are subjected to prism processing without any annealing treatment and refractive indices thereof are measured.

The measured refractive index values of the above glass molded articles are compared with the target refractive index, and the molding condition (cooling rate) of the glass molded article having a refractive index value coincident with or closest to the target refractive index is determined as an implementation condition.

In the case where the refractive index is not coincident with the target refractive index, if necessary, it is also possible to cope therewith by fine adjustment of the cooling rate. Alternatively, since the refractive index can be increased in a minute degree by a thermal treatment at a low temperature set to a temperature 150° C. or more lower than a strain point of the glass, the fine adjustment of 50×10⁻⁵ or less by this method can be utilized additionally or can be utilized instead of the adjustment by the cooling rate.

### <Step 5: Production of Glass Molded Article>

A glass having the implementation composition determined in the above step is prepared and the resultant glass having the implementation composition is subjected to press molding in accordance with the implementation condition determined in the above step to obtain a glass molded article.

When the implementation composition and the implementation molding condition determined in the above are adopted, it is easy to make a difference in refractive index from the target refractive index about 50×10⁻⁵ or less. When the tolerance of a refractive index (generally about ±30×10⁻⁵) on the production of glass products is considered, it is preferable to make the refractive index close to the target refractive index as far as possible. However, in the case where the tolerance of the refractive index of a molded article such as a lens is such a large value as ±70×10⁻⁵, the fine adjustment of a refractive index by changing a design condition in Step 4 is omitted.

By the production through the selection of the glass composition and the molding condition according to steps 1 to 5, the glass composition and the molding condition can be optimized for a short period of time. Utilizing these procedures, an optical glass element having a desired refractive index can be produced efficiently with high accuracy by press molding without any annealing treatment.

When a time required for the above production process is estimated, the time is as follows, for example.

Step 1: selection of candidate compositions (0H);

Step 2: preparation of glass materials having candidate compositions (glass blending 1H, charging into crucible 1H, melting 2H, solidification 1H, annealing treatment 8H), cutting 0.5H, and press molding 1.5H: total 15H;

Step 3: prism processing (2H), measurement of refractive index (1H), and determination of implementation composition (0H);

Step 4: press molding into optical element with changing molding condition (PF processing 8H and press molding 1.5H), prism processing (2H), and measurement of refractive index (1H), determination of implementation composition (0H); and

Step 5: implementation of production method with implementation composition and under implementation molding conditions.

According to the above, a time required for reaching full implementation is 30.5 hours in total. When the required time is estimated for the methods of the above Patent Documents 1 and 2, the time is 73.5 to 180 hours for 10 to 16 steps in Patent Document 1 and the time is 62.5 to 105 hours for 10 to 16 steps in Patent Document 2. In comparison therewith, the glass composition and the molding condition can be optimized for a short period of time in the invention. In the case where the tolerance of the refractive index of a lens is large, the required time is 18 hours for a total of 4 steps when steps 5, 6, and 7 are omitted, the time and the number of steps being one fourth of the conventional ones.

In the above embodiment, the allocation of the candidate compositions is constituted using the variation in optical property at the time when a constitutional component of a glass composition is replaced. However, in the invention, without limitation to the method, the correspondence of the composition to the optical property may be prepared using the other property which is easily handled by a developer. Moreover, when the constitution is conducted with attaching various properties which may be possibly referred to in optical design, convenience is enhanced. For example, Abbe number ν_{d} which is an important parameter in the optical design does not so largely change even in the case where an annealing treatment is not subjected or is subjected and only changes within the range of tolerance of lens design, so that a good design result is obtained when aptness is fitted by reference at a stage of developing the basic composition.

When operated as mentioned above, the most suitable glass composition for obtaining an optical glass element having a desired refractive index can be efficiently selected utilizing the refractive index data of the regular glass compositions and furthermore fine adjustment of the refractive index is possible by changing a molding condition as needed, so that various optical glass elements can be conveniently produced by press molding with omitting the anneal treatment. Moreover, by setting the optical property data of the glass having a regular composition subjected to the annealing treatment to the target refractive index value as it is, change in composition and change in molding condition for use in product design of press molding with omitting the annealing treatment are conducted and thus switching of the production method to annealing-less press molding can be easily performed.

Furthermore, since a composition for use in the production of an optical product having a desired optical property can be rapidly determined, design can be efficiently advanced using the composition.

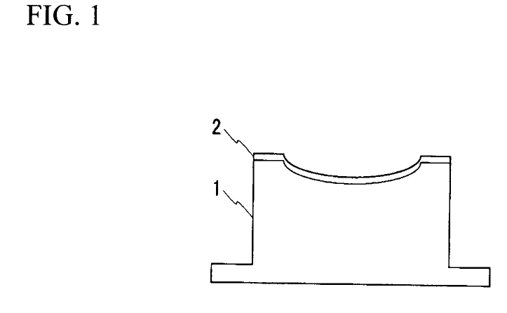

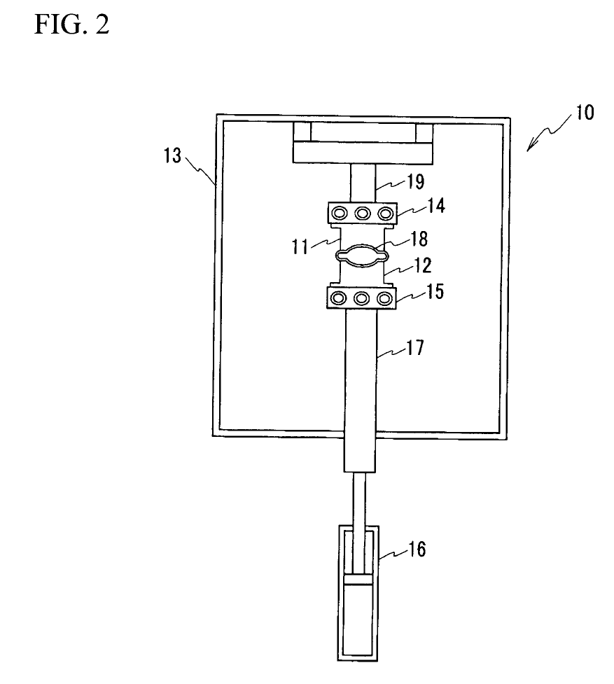

Incidentally, one example of a mold and a molding apparatus to be used in press molding of glass is shown in FIG. 1 and FIG. 2, respectively.

FIG. 1 shows a lower mold of a pair of upper and lower molds to be used for molding a ball lens and has a cemented carbide part 1 having an aspheric concave pressing surface formed on one end surface of a column made of cemented carbide and a coating film 2 having an Ir—Re composition which covers the concave pressing surface. The coating film 2 is formed through a Ti film (not shown in the figure) for imparting adhesiveness with the cemented carbide.

FIG. 2 shows a press molding apparatus 10, into which upper and lower molds 11, 12 having a structure as shown in FIG. 1 are incorporated. In press molding, after the inside of a chamber 13 is made an N₂ atmosphere, the upper mold 11 and the lower mold 12 are heated by heater blocks 14, 15. At the time when the temperature reaches a temperature where the viscosity of a glass to be molded is about 10⁻⁹ dPa·s, a lower shaft 17 is drawn down by means of a hydraulic cylinder 16 and an article to be mold 18 is placed on the lower mold 12. While the temperature of the mold is maintained, the lower shaft 17 is elevated by means of the hydraulic cylinder 16 and the article is pressed with the upper mold 11 and the lower mold 12. Usually, molding pressure is about 100 to 5000 N and molding time is about 0.1 to 1 minute. Then, the temperature is lowered at a predetermined cooling rate. At the time when the temperature of the upper and lower molds reaches a temperature about 30° C. lower than the temperature of Tg of a sample having the basic composition, the lower mold 12 is moved downward and the article to be molded 18 is removed from the lower mold 12 and taken out of the chamber 13. In this example, the lower mold 12 is movable but the structure may be a structure wherein the upper mold 11 is moved by means of an upper shaft 19.

The following will specifically describe embodiments of the invention with reference to Examples.

### EXAMPLES

In order to produce four glass molded articles without any annealing treatment whose refractive indices are the same as those of four glass molded articles produced with an annealing treatment after press molding, in the following Examples 1 to 4, glass compositions and molding conditions were individually determined and production was carried out.

### Glass Compositions and Physical Properties of Molded Articles with Annealing Treatment

### Example 1

Borosilicate glass SK12: n_{d}=1.58313, ν_{d}=59.4, transition point Tg=500° C., yield point=540° C., basic composition (% by mass) was as follows: SiO₂: 47%, B₂O₃: 9.5%, Al₂O₃: 4%, Li₂O: 6%, Na₂O: 5%, K₂O: 0.6%, SrO: 0.1%, BaO: 27%, ZnO: 4%, Sb₂O₃: 0.3%.

### Example 2

High-refractive index lanthanum-based glass LaSF03: n_{d}=1.80610, ν_{d}=40.9, transition point Tg=610° C., yield point=637° C., basic composition (% by mass) was as follows: SiO₂: 6%, B₂O₃: 21%, WO₃: 4%, BaO: 3%, Al₂O₃: 1%, ZnO: 12%, ZrO₂: 4%, La₂O₃: 39%, Nb₂O₅: 10%.

### Example 3

Medium-refractive index lanthanum-based glass LaK13: n_{d}=1.69350, ν_{d}=53.2, transition point Tg=534° C., yield point=575° C., basic composition (% by mass) was as follows: SiO₂: 12%, B₂O₃: 26%, Y₂O₃: 10%, BaO: 9%, CaO: 5%, SrO: 6%, ZnO: 6%, ZrO₂: 3%, La₂O₃: 17%, Ta₂O₅: 2%, Li₂O 4%.

### Example 4

Lead-free SF-based glass: n_{d}=1.83917, ν_{d}=23.9, transition point Tg=477° C., yield point=515° C., basic composition (% by mass) was as follows: SiO₂: 1%, P₂O₃: 24%, WO₃: 10%, Bi₂O₃: 11%, Nb₂O₅: 38%, BaO: 4%, B₂O₃: 2%, Na₂O: 8%, Li₂O: 2%.

### Arrangement of Basic Data

### Example 1

Using the above-mentioned borosilicate glass SK12 (hereinafter referred to as SK12) as a basic composition, measured values of the refractive index n_{d} in the basic composition, the change ratio of refractive index (the variation in refractive index n_{d} when a component to be replaced is replaced with a replacing component in an amount of 1% by mass), Abbe number ν_{d}, and the change ratio of Abbe number (the variation in Abbe number ν_{d} when a component to be replaced is replaced with a replacing component in an amount of 1% by mass) were provided (the refractive index n_{d} and the Abbe number ν_{d} were measured values with helium d line having a wavelength of 587.56 nm). The refractive index was measured using a Pulfrich-type refractometer (manufactured by Shimadzu Device Corporation, trade name: KPR-200). The measured value was obtained using a sample subjected to a certain annealing treatment depending on the glass transition temperature of the glass material (after 1 hour of maintenance at (Tg+15)° C. of the glass material, the sample was cooled at a constant rate of 60° C./hour until (Tg−200)° C. and then allowed to cool on standing).

Based on the fact that the change ratio of refractive index showed the variation in refractive index n_{d} when a component to be replaced was replaced with a replacing component in an amount of 1% by mass, as shown in Table 1, a replacement amount M (% by mass) for increasing the refractive index n_{d} by 50×10⁻⁵ was calculated from the known change ratio of refractive index of glass according to the following equation. In the case of the borosilicate glass SK12, the replacement amount M is 50/230=0.217.

Replacement amount M (% by mass)=(50×10⁻⁵)/(Change Ratio of Refractive Index)

TABLE 1

| | Kind of glass | | | |
|---|---|---|---|---|
| | SK12 | LaSF03 | LaK13 | Lead-free SF |
| Replacing | SiO₂ → | B₂O₃ → | B₂O₃ → La₂O₃ | P₂O₅ → Nb₂O₅ |
| component | BaO | La₂O₃ | | |
| Change in n_{d} at | +230 | +640 | +384 | +1690 |
| 1% by mass of | | | | |
| replacement | | | | |
| Change in ν_{d} at | −0.10 | −0.04 | −0.5 | −0.85 |
| 1% by mass of | | | | |
| replacement | | | | |
| Replacement | 0.217 | 0.078 | 0.130 | 0.030 |
| amount | | | | |
| corresponding | | | | |
| to variation | | | | |
| in n_{d} + | | | | |
| 50 × 10⁻⁵ | | | | |
| Variation in ν_{d} | −0.022 | −0.003 | −0.065 | −0.026 |
| corresponding | | | | |
| to variation | | | | |
| in n_{d} + | | | | |
| 50 × 10⁻⁵ | | | | |

### Example 2

Using the above-mentioned high-refractive index lanthanum-based glass LaSF03 (hereinafter referred to as LaSFO3) as a basic composition, measured values of the refractive index n_{d} in the basic composition, the change ratio of refractive index (the variation in refractive index n_{d} when a component to be replaced is replaced with a replacing component in an amount of 1% by mass), Abbe number ν_{d}, and the change ratio of Abbe number (the variation in Abbe number ν_{d} when a component to be replaced is replaced with a replacing component in an amount of 1% by mass) were provided.

Based on the data of the above glass having the base composition, a replacement amount M (% by mass) for increasing the refractive index n_{d} by 50×10⁻⁵ was calculated from the change ratio of refractive index according to the above equation in the same manner as in Example 1. The results are shown in Table 1.

### Example 3

Using the above-mentioned medium-refractive index lanthanum-based glass LaK13 (hereinafter referred to as LaK13) as a basic composition, measured values of the refractive index n_{d} in the basic composition, the change ratio of refractive index (the variation in refractive index n_{d} when a component to be replaced is replaced with a replacing component in an amount of 1% by mass), Abbe number ν_{d}, and the change ratio of Abbe number (the variation in Abbe number ν_{d} when a component to be replaced is replaced with a replacing component in an amount of 1% by mass) were provided.

Based on the data of the above glass having the base composition, a replacement amount M (% by mass) for increasing the refractive index n_{d} by 50×10⁻⁵ was calculated from the change ratio of refractive index according to the above equation in the same manner as in Example 1. The results are shown in Table 1.

### Example 4

Using the above-mentioned lead-free SF-based glass (hereinafter referred to as SF) as a basic composition, measured values of the refractive index n_{d} in the basic composition, the change ratio of refractive index (the variation in refractive index n_{d} when a component to be replaced is replaced with a replacing component in an amount of 1% by mass), Abbe number ν_{d}, and the change ratio of Abbe number (the variation in Abbe number ν_{d} when a component to be replaced is replaced with a replacing component in an amount of 1% by mass) were provided.

Based on the data of the above glass having the base composition, a replacement amount M (% by mass) for increasing the refractive index n_{d} by 50×10⁻⁵ was calculated from the change ratio of refractive index according to the above equation in the same manner as in Example 1. The results are shown in Table 1.

### <Selection of Candidate Compositions>

Based on the above basic date, candidate compositions were selected according to the following procedure for each of Examples 1 to 4.

First, as one specific example of the range of estimated refractive index values which might be a range wherein the values of target refractive index+(100 to 850)×10⁻⁵ were upper and lower limits, a range which varies by 100×10⁻⁵ to 850×10⁻⁵ from the refractive index in the basic composition was set. By setting the range, the range of the corresponding compositions to be determined in the following is defined as a range of candidate compositions. Then, within the range, the estimated refractive index values were allocated so that the step width of the refractive index is 50×10⁻⁵ (10×10⁻⁵, 150×10⁻⁵, 200×10⁻⁵, . . . , 850×10⁻⁵) and respective glass compositions corresponding to these estimated refractive index values were determined, thereby data comprising the estimated refractive index values varying at intervals of 50×10⁻⁵ and the glass compositions being prepared. These glass compositions are candidate compositions.

Specifically, first, a value m defining the range was assigned to a natural numbers 2 to 17 and the values of the replacement amount M×m were calculated. Then, using the calculated values M×m, glass compositions corresponding to the refractive indices varying by 50×10⁻⁵×m at intervals of 50×10⁻⁵ from the refractive index in the basic composition (variation: from +10×10⁻⁵ to +850×10⁻⁵), thereby data of the glass compositions and the estimated refractive index values being constituted. For example, in the case of determining a composition where the refractive index is higher by 350×10⁻⁵ in borosilicate glass SK12 (m=(350×10⁻⁵)/(50×10⁻⁵)=7), the content (% by mass) of SiO₂ is (content of SiO₂ in basic composition)−M×m=47−0.217×7=45.481 and the content (% by mass) of BaO is (content of BaO in basic composition)+M×m=27+0.217×7=28.519. The results in Example 1 are shown in Table 2, the results in Example 2 are shown in Table 3, the results in Example 3 are shown in Table 4, and the results in Example 4 are shown in Table 5, respectively.

In this connection, as referential data for optical design, the estimated values of Abbe number in the above compositions were determined using the change ratio of Abbe number. In detail, the variation in ν_{d} when the refractive index n_{d} is increased by 50×10⁻⁵ is a product of multiplying the change ratio of Abbe number (ν_{d}) at 1% by mass of replacement by the above replacement amount M (% by mass), and thus the variation in ν_{d} of borosilicate glass SK12 is −0.10×0.217=−0.0217. In each data in Tables 2 to 5, values of n_{d}, ν_{d}, Tg, and At in the basic composition are measured values and the values in the other compositions are estimated values by calculation.

TABLE 2

| | | Kind of glass | | | | | | | | |
|---|---|---|---|---|---|---|---|---|---|---|
| | | SK12 | | | | | | | | |
| | | Composition | | | | | | | | |
| | | Basic | | | | | | | | |
| | | composition | m = 2 | m = 3 | m = 4 | m = 5 | m = 6 | m = 7 | m = 8 | m = 9 |
| Component | SiO₂ | 47 | 46.566 | 46.349 | 46.132 | 45.915 | 45.698 | 45.481 | 45.264 | 45.047 |
| (% by mass) | BaO | 27 | 27.434 | 27.651 | 27.868 | 28.085 | 28.302 | 28.519 | 28.736 | 28.953 |
| | B₂O₃ | 9.5 | 9.5 | 9.5 | 9.5 | 9.5 | 9.5 | 9.5 | 9.5 | 9.5 |
| | Al₂O₃ | 4 | 4 | 4 | 4 | 4 | 4 | 4 | 4 | 4 |
| | Li₂O | 6 | 6 | 6 | 6 | 6 | 6 | 6 | 6 | 6 |
| | Na₂O | 1.5 | 1.5 | 1.5 | 1.5 | 1.5 | 1.5 | 1.5 | 1.5 | 1.5 |
| | K₂O | 0.6 | 0.6 | 0.6 | 0.6 | 0.6 | 0.6 | 0.6 | 0.6 | 0.6 |
| | SrO | 0.1 | 0.1 | 0.1 | 0.1 | 0.1 | 0.1 | 0.1 | 0.1 | 0.1 |
| | ZnO | 4 | 4 | 4 | 4 | 4 | 4 | 4 | 4 | 4 |
| | Sb₂O₃ | 0.3 | 0.3 | 0.3 | 0.3 | 0.3 | 0.3 | 0.3 | 0.3 | 0.3 |

| | | | | | | | | | |
|---|---|---|---|---|---|---|---|---|---|
| n_{d} and estimated value | 1.58313 | 1.58413 | 1.58463 | 1.58513 | 1.58563 | 1.58613 | 1.58663 | 1.58713 | 1.58763 |
| ν_{d} and estimated value | 59.4 | 59.36 | 59.33 | 59.31 | 59.29 | 59.27 | 59.25 | 59.23 | 59.20 |
| Tg | 500 | | | | | | | | |
| At | 540 | | | | | | | | |

| | | Kind of glass | | | | | | | |
|---|---|---|---|---|---|---|---|---|---|
| | | SK12 | | | | | | | |
| | | Composition | | | | | | | |
| | | m = 10 | m = 11 | m = 12 | m = 13 | m = 14 | m = 15 | m = 16 | m = 17 |
| Component | SiO₂ | 44.83 | 44.613 | 44.396 | 44.179 | 43.962 | 43.745 | 43.528 | 43.311 |
| (% by mass) | BaO | 29.17 | 29.387 | 29.604 | 29.821 | 30.038 | 30.255 | 30.472 | 30.689 |
| | B₂O₃ | 9.5 | 9.5 | 9.5 | 9.5 | 9.5 | 9.5 | 9.5 | 9.5 |
| | Al₂O₃ | 4 | 4 | 4 | 4 | 4 | 4 | 4 | 4 |
| | Li₂O | 6 | 6 | 6 | 6 | 6 | 6 | 6 | 6 |
| | Na₂O | 1.5 | 1.5 | 1.5 | 1.5 | 1.5 | 1.5 | 1.5 | 1.5 |
| | K₂O | 0.6 | 0.6 | 0.6 | 0.6 | 0.6 | 0.6 | 0.6 | 0.6 |
| | SrO | 0.1 | 0.1 | 0.1 | 0.1 | 0.1 | 0.1 | 0.1 | 0.1 |
| | ZnO | 4 | 4 | 4 | 4 | 4 | 4 | 4 | 4 |
| | Sb₂O₃ | 0.3 | 0.3 | 0.3 | 0.3 | 0.3 | 0.3 | 0.3 | 0.3 |

| | | | | | | | | |
|---|---|---|---|---|---|---|---|---|
| n_{d} and estimated value | 1.58813 | 1.58863 | 1.58913 | 1.58963 | 1.59013 | 1.59063 | 1.59113 | 1.59163 |
| ν_{d} and estimated value | 59.18 | 59.16 | 59.14 | 59.12 | 59.10 | 59.07 | 59.05 | 59.03 |
| Tg | | | | | | | | |
| At | | | | | | | | |

TABLE 3

| | | Kind of glass | | | | | | | | |
|---|---|---|---|---|---|---|---|---|---|---|
| | | LaSF03 | | | | | | | | |
| | | Composition | | | | | | | | |
| | | Basic | | | | | | | | |
| | | composition | m = 2 | m = 3 | m = 4 | m = 5 | m = 6 | m = 7 | m = 8 | m = 9 |
| Component | B₂O₃ | 21 | 20.844 | 20.766 | 20.688 | 20.61 | 20.532 | 20.454 | 20.376 | 20.298 |
| (% by mass) | La₂O₃ | 39 | 39.156 | 39.234 | 39.312 | 39.39 | 39.468 | 39.546 | 39.624 | 39.702 |
| | SiO₂ | 6 | 6 | 6 | 6 | 6 | 6 | 6 | 6 | 6 |
| | BaO | 3 | 3 | 3 | 3 | 3 | 3 | 3 | 3 | 3 |
| | Al₂O₃ | 1 | 1 | 1 | 1 | 1 | 1 | 1 | 1 | 1 |
| | WO₃ | 4 | 4 | 4 | 4 | 4 | 4 | 4 | 4 | 4 |
| | Nb₂O₅ | 10 | 10 | 10 | 10 | 10 | 10 | 10 | 10 | 10 |
| | ZrO₂ | 4 | 4 | 4 | 4 | 4 | 4 | 4 | 4 | 4 |
| | ZnO | 12 | 12 | 12 | 12 | 12 | 12 | 12 | 12 | 12 |

| | | | | | | | | | |
|---|---|---|---|---|---|---|---|---|---|
| n_{d} and estimated value | 1.80610 | 1.80710 | 1.80760 | 1.80810 | 1.80860 | 1.80910 | 1.80960 | 1.81010 | 1.81060 |
| ν_{d} and estimated value | 40.9 | 40.89 | 40.89 | 40.89 | 40.89 | 40.88 | 40.88 | 40.88 | 40.87 |
| Tg | 610 | | | | | | | | |
| At | 637 | | | | | | | | |

| | | Kind of glass | | | | | | | |
|---|---|---|---|---|---|---|---|---|---|
| | | LaSF03 | | | | | | | |
| | | Composition | | | | | | | |
| | | m = 10 | m = 11 | m = 12 | m = 13 | m = 14 | m = 15 | m = 16 | m = 17 |
| Component | B₂O₃ | 20.22 | 20.142 | 20.064 | 19.986 | 19.908 | 19.83 | 19.752 | 19.674 |
| (% by mass) | La₂O₃ | 39.78 | 39.858 | 39.936 | 40.014 | 40.092 | 40.17 | 40.248 | 40.326 |
| | SiO₂ | 6 | 6 | 6 | 6 | 6 | 6 | 6 | 6 |
| | BaO | 3 | 3 | 3 | 3 | 3 | 3 | 3 | 3 |
| | Al₂O₃ | 1 | 1 | 1 | 1 | 1 | 1 | 1 | 1 |
| | WO₃ | 4 | 4 | 4 | 4 | 4 | 4 | 4 | 4 |
| | Nb₂O₅ | 10 | 10 | 10 | 10 | 10 | 10 | 10 | 10 |
| | ZrO₂ | 4 | 4 | 4 | 4 | 4 | 4 | 4 | 4 |
| | ZnO | 12 | 12 | 12 | 12 | 12 | 12 | 12 | 12 |

| | | | | | | | | |
|---|---|---|---|---|---|---|---|---|
| n_{d} and estimated value | 1.81110 | 1.81160 | 1.81210 | 1.81260 | 1.81310 | 1.81360 | 1.81410 | 1.81460 |
| ν_{d} and estimated value | 40.87 | 40.87 | 40.86 | 40.86 | 40.86 | 40.86 | 40.85 | 40.85 |
| Tg | | | | | | | | |
| At | | | | | | | | |

TABLE 4

| | | Kind of glass | | | | | | | | |
|---|---|---|---|---|---|---|---|---|---|---|
| | | LaK13 | | | | | | | | |
| | | Composition | | | | | | | | |
| | | Basic | | | | | | | | |
| | | composition | m = 2 | m = 3 | m = 4 | m = 5 | m = 6 | m = 7 | m = 8 | m = 9 |
| Component | B₂O₃ | 26 | 25.74 | 25.61 | 25.48 | 25.35 | 25.22 | 25.09 | 24.96 | 24.83 |
| (% by mass) | La₂O₃ | 17 | 17.26 | 17.39 | 17.52 | 17.65 | 17.78 | 17.91 | 18.04 | 18.17 |
| | Ta₂O₅ | 2 | 2 | 2 | 2 | 2 | 2 | 2 | 2 | 2 |
| | LiO₂ | 4 | 4 | 4 | 4 | 4 | 4 | 4 | 4 | 4 |
| | SiO₂ | 12 | 12 | 12 | 12 | 12 | 12 | 12 | 12 | 12 |
| | BaO | 9 | 9 | 9 | 9 | 9 | 9 | 9 | 9 | 9 |
| | Y₂O₃ | 10 | 10 | 10 | 10 | 10 | 10 | 10 | 10 | 10 |
| | CaO | 5 | 5 | 5 | 5 | 5 | 5 | 5 | 5 | 5 |
| | SrO | 6 | 6 | 6 | 6 | 6 | 6 | 6 | 6 | 6 |
| | ZrO₂ | 3 | 3 | 3 | 3 | 3 | 3 | 3 | 3 | 3 |
| | ZnO | 6 | 6 | 6 | 6 | 6 | 6 | 6 | 6 | 6 |

| | | | | | | | | | |
|---|---|---|---|---|---|---|---|---|---|
| n_{d} and estimated value | 1.69350 | 1.69450 | 1.69500 | 1.69550 | 1.69600 | 1.69650 | 1.69700 | 1.69750 | 1.69800 |
| ν_{d} and estimated value | 53.2 | 53.07 | 53.01 | 52.94 | 52.88 | 52.81 | 52.75 | 52.68 | 52.62 |
| Tg | 534 | | | | | | | | |
| At | 575 | | | | | | | | |

| | | Kind of glass | | | | | | | |
|---|---|---|---|---|---|---|---|---|---|
| | | LaK13 | | | | | | | |
| | | Composition | | | | | | | |
| | | m = 10 | m = 11 | m = 12 | m = 13 | m = 14 | m = 15 | m = 16 | m = 17 |
| Component | B₂O₃ | 24.7 | 24.57 | 24.44 | 24.31 | 24.18 | 24.05 | 23.92 | 23.79 |
| (% by mass) | La₂O₃ | 18.3 | 18.43 | 18.56 | 18.69 | 18.82 | 18.95 | 19.08 | 19.21 |
| | Ta₂O₅ | 2 | 2 | 2 | 2 | 2 | 2 | 2 | 2 |
| | LiO₂ | 4 | 4 | 4 | 4 | 4 | 4 | 4 | 4 |
| | SiO₂ | 12 | 12 | 12 | 12 | 12 | 12 | 12 | 12 |
| | BaO | 9 | 9 | 9 | 9 | 9 | 9 | 9 | 9 |
| | Y₂O₃ | 10 | 10 | 10 | 10 | 10 | 10 | 10 | 10 |
| | CaO | 5 | 5 | 5 | 5 | 5 | 5 | 5 | 5 |
| | SrO | 6 | 6 | 6 | 6 | 6 | 6 | 6 | 6 |
| | ZrO₂ | 3 | 3 | 3 | 3 | 3 | 3 | 3 | 3 |
| | ZnO | 6 | 6 | 6 | 6 | 6 | 6 | 6 | 6 |

| | | | | | | | | |
|---|---|---|---|---|---|---|---|---|
| n_{d} and estimated value | 1.69850 | 1.69900 | 1.69950 | 1.70000 | 1.70050 | 1.70100 | 1.70150 | 1.70200 |
| ν_{d} and estimated value | 52.55 | 52.49 | 52.42 | 52.36 | 52.29 | 52.23 | 52.16 | 52.10 |
| Tg | | | | | | | | |
| At | | | | | | | | |

TABLE 5

| | | Kind of glass | | | | | | | | |
|---|---|---|---|---|---|---|---|---|---|---|
| | | Lead-free SF | | | | | | | | |
| | | Composition | | | | | | | | |
| | | Basic | | | | | | | | |
| | | composition | m = 2 | m = 3 | m = 4 | m = 5 | m = 6 | m = 7 | m = 8 | m = 9 |
| Component | P₂O₅ | 24 | 23.94 | 23.91 | 23.88 | 23.85 | 23.82 | 23.79 | 23.76 | 23.73 |
| (% by mass) | Nb₂O₅ | 38 | 38.06 | 38.09 | 38.12 | 38.15 | 38.18 | 38.21 | 38.24 | 38.27 |
| | WO₃ | 10 | 10 | 10 | 10 | 10 | 10 | 10 | 10 | 10 |
| | Bi₂O₃ | 11 | 11 | 11 | 11 | 11 | 11 | 11 | 11 | 11 |
| | B₂O₃ | 2 | 2 | 2 | 2 | 2 | 2 | 2 | 2 | 2 |
| | BaO | 4 | 4 | 4 | 4 | 4 | 4 | 4 | 4 | 4 |
| | Na₂O | 8 | 8 | 8 | 8 | 8 | 8 | 8 | 8 | 8 |
| | Li₂O | 2 | 2 | 2 | 2 | 2 | 2 | 2 | 2 | 2 |
| | SiO₂ | 1 | 1 | 1 | 1 | 1 | 1 | 1 | 1 | 1 |

| | | | | | | | | | |
|---|---|---|---|---|---|---|---|---|---|
| n_{d} and estimated value | 1.83917 | 1.84017 | 1.84067 | 1.84117 | 1.84167 | 1.84217 | 1.84267 | 1.84317 | 1.84367 |
| ν_{d} and estimated value | 23.9 | 23.85 | 23.82 | 23.80 | 23.77 | 23.74 | 23.72 | 23.69 | 23.67 |
| Tg | 477 | | | | | | | | |
| At | 515 | | | | | | | | |

| | | Kind of glass | | | | | | | |
|---|---|---|---|---|---|---|---|---|---|
| | | Lead-free SF | | | | | | | |
| | | Composition | | | | | | | |
| | | m = 10 | m = 11 | m = 12 | m = 13 | m = 14 | m = 15 | m = 16 | m = 17 |
| Component | P₂O₅ | 23.7 | 23.67 | 23.64 | 23.61 | 23.58 | 23.55 | 23.52 | 23.49 |
| (% by mass) | Nb₂O₅ | 38.3 | 38.33 | 38.36 | 38.39 | 38.42 | 38.45 | 38.48 | 38.51 |
| | WO₃ | 10 | 10 | 10 | 10 | 10 | 10 | 10 | 10 |
| | Bi₂O₃ | 11 | 11 | 11 | 11 | 11 | 11 | 11 | 11 |
| | B₂O₃ | 2 | 2 | 2 | 2 | 2 | 2 | 2 | 2 |
| | BaO | 4 | 4 | 4 | 4 | 4 | 4 | 4 | 4 |
| | Na₂O | 8 | 8 | 8 | 8 | 8 | 8 | 8 | 8 |
| | Li₂O | 2 | 2 | 2 | 2 | 2 | 2 | 2 | 2 |
| | SiO₂ | 1 | 1 | 1 | 1 | 1 | 1 | 1 | 1 |

| | | | | | | | | |
|---|---|---|---|---|---|---|---|---|
| n_{d} and estimated value | 1.84417 | 1.84467 | 1.84517 | 1.84567 | 1.84617 | 1.84667 | 1.84717 | 1.84767 |
| ν_{d} and estimated value | 23.64 | 23.61 | 23.59 | 23.56 | 23.54 | 23.51 | 23.48 | 23.46 |
| Tg | | | | | | | | |
| At | | | | | | | | |

### <Preparation of Samples Having Candidate Composition>

For the candidate compositions in Tables 2 to 5, glass materials were blended according to the component data shown in the tables. The blending was performed in an assembly-line operation manner at a time and thus not so much time was required even when the number of blends increases.

Using a plurality of platinum crucibles, the blends were individually charged into the crucibles at room temperature and the crucibles were inserted into an electric furnace maintained at 1300° C. to melt the total amount at once. After 1 hour of insertion, the crucibles were taken out, stirred with a platinum bar, and again charged into the electric furnace at 1300° C. After 2 hours of maintenance, they were cooled to a temperature suitable for casting (1000° C.) over a period of 1 hour and then the crucibles were taken out and the contents were cast into molds. The cast glass materials were charged into an electric furnace maintained at an annealing temperature suitable for each glass composition (herein (Tg+15)° C. of basic composition of each glass) for 1 hour and then cooled to (Tg−200)° C. at a constant cooling rate of 60° C./hour, thereby an annealing treatment being conducted. Then, they were allowed to cool on standing to obtain samples. Since it is not necessary to measure optical properties of the resultant samples, the annealing treatment may be such a rough treatment that they are not cracked during processing. A time required for the process from charging the glass raw materials until obtaining the samples was about 8 hours. In this connection, three to four kinds of glass compositions are treated at the same time every composition system but, depending on thermal properties of each glass composition, it is desired to vitrify and cast each composition at a temperature that is most suitable for it.

### <Molding and Measurement of Refractive Index>

A column made of cemented carbide having a size of diameter 18 mm×height 50 mm was processed to form a mold for press molding composed of a pair of upper and lower molds having an aspheric pressing surface (about 14 mm in diameter) having a concave shape whose approximate curvature radius was 16 mm.

Moreover, after a pressing surface of another set of upper and lower molds the same as mentioned above was polished into a mirror surface with diamond abrasive grains of 0.1 μm, a Ti film of 50 nm was formed on the mirror surface by spattering method and then a coating film having a composition wherein a mass ratio of Ir to Re was 4:1 was formed in a film thickness of 250 nm, thereby a mold for evaluation being prepared. A cross-section of the lower mold part of the mold is shown in FIG. 1. In the figure, reference numeral 1 represents a cemented carbide part of the lower mold and reference numeral 2 represents a coating film (the Ti film is not shown in the figure). The Ti film is a film for improving adhesiveness between the cemented carbide part 1 and the coating film 2.

Then, each sample having each candidate composition prepared in the above was cut into a cube about 10 mm square by means of a diamond cutter and the cube was molded according to the following procedure using a press molding apparatus 10 shown in FIG. 2 into which the aforementioned press molding mold was incorporated as upper and lower molds 11, 12.

First, after the chamber 13 was evacuated by a vacuum pump (not shown in the figure), the inside of the chamber 13 was made an N₂ atmosphere by introducing N₂ gas and then the upper mold 11 and the lower mold 12 were heated by heater blocks 14, 15. At the time when the temperature reached a temperature where the viscosity of the glass to be molded was about 10⁻⁹ dPa·s (SK12: 570° C., LaSFO3: 660° C., LaK13: 600° C., lead-free SF-based glass: 545° C.), the lower shaft 17 was drawn down by the hydraulic cylinder 16 and an article to be mold (the cubic sample) 18 was placed on the lower mold 12 using an auto-hand (not shown in the figure).

Then, after 3 minutes had passed with maintaining the mold temperature, the lower shaft 17 was elevated by the hydraulic cylinder 16 and the article was pressed with the upper mold 11 and the lower mold 12 under a molding pressure of 3000 N to mold the cubic glass lump into a lens shape. Thereafter, the sample was cooled at a cooling rate of 80° C./minute and, at the time when the temperature of the upper and lower molds reached a temperature (SK12: 485° C., LaSFO3: 580° C., LaK13: 504° C., lead-free SF-based glass: 447° C.) about 30° C. lower than the temperature of Tg of a sample having the basic composition, the lower mold 12 was moved downward. The molded sample 18 was taken out of the lower mold 12 by means of an auto-hand and recovered from the chamber 13 through a replacing apparatus (not shown in the figure).

The sample after molding was adhered with resin wax to a jig for grinding and the jig was mounted on a transverse grinding apparatus and one surface thereof was ground for 5 minutes. Then, the jig was once removed and, after rotated by 90°, again mounted on the grinding apparatus and then another surface was processed for 5 minutes. The refractive index of the resultant 90° prism was measured on a Pulfrich-type refractometer.

### <Determination of Implementation Composition>

In each of Examples 1 to 4, with regard to some compositions wherein the measured refractive index values are closest to the target refractive index among the samples having candidate compositions, the results are shown in Table 6.

The composition of m=6 in Example 1, the composition of m=10 in Example 2, the composition of m=8 in Example 3, and the composition of m=14 in Example 4 were selected as respective implementation compositions. The difference d between the target refractive index and each of these refractive indices is 13×10⁻⁵ to 25×10⁻⁵ and thus no composition is coincident with the target refractive index but the difference d is not larger than 50×10⁻⁵.

TABLE 6

| | Kind of glass | | | | | | |
|---|---|---|---|---|---|---|---|
| | SK12 | | | LaSF03 | | | |
| | Composition | | | | | | |
| | m = 6 | m = 7 | m = 8 | m = 8 | m = 9 | m = 10 | m = 11 |
| Refractive index | 1.58333 | 1.58389 | 1.58421 | 1.80512 | 1.80555 | 1.80624 | 1.80657 |
| of molded article | | | | | | | |
| Difference from | +20 | +76 | +108 | −98 | −55 | +14 | +47 |
| target refractive | | | | | | | |
| index n (×10⁻⁵) | | | | | | | |
| | Implementation | | | | | Implementation | |

| | Kind of glass | | | | | | |
|---|---|---|---|---|---|---|---|
| | LaK13 | | | Lead-free SF | | | |
| | Composition | | | | | | |
| | m = 6 | m = 7 | m = 8 | m = 12 | m = 13 | m = 14 | m = 15 |
| Refractive | 1.69250 | 1.69320 | 1.69375 | 1.83795 | 1.83856 | 1.83904 | 1.83961 |
| index of | | | | | | | |
| molded article | | | | | | | |
| Difference | −100 | −30 | +25 | −122 | −61 | −13 | +44 |
| from target | | | | | | | |
| refractive index | | | | | | | |
| n (×10⁻⁵) | | | | | | | |
| | | | Implementation | | | Implementation | |

### <Change in Molding Condition>

In each of Examples 1 to 4, a polishing ball having a size suitable for lens molding was prepared using rest of the casting glass sample having the determined implementation composition. The polishing ball was subjected to press molding under the same conditions as in the press molding in the aforementioned measurement of refractive index except that the cooling rate after pressing was changed to any of 70° C./min, 80° C./min, 90° C./min, 100° C./min, and 110° C./min, thereby five kinds of samples with different cooling rates being obtained for each Example.

The molded samples were subjected to prism processing in the same manner as in the aforementioned measurement of the refractive index to prepare 90° prisms and the refractive indices thereof were measured. The measured results are shown in Table 7.

TABLE 7

| | Kind of glass | | | | | | | | | |
|---|---|---|---|---|---|---|---|---|---|---|
| | SK12 | | | | | LaSF03 | | | | |
| | Composition | | | | | | | | | |
| | m = 6 | | | | | m = 10 | | | | |
| Cooling rate | 70 | 80 | 90 | 100 | 110 | 70 | 80 | 90 | 100 | 110 |
| (° C./min) | | | | | | | | | | |
| Refractive index of | 1.58344 | 1.58338 | 1.58329 | 1.58320 | 1.58311 | 1.80642 | 1.80630 | 1.80622 | 1.80615 | 1.80607 |
| molded article | | | | | | | | | | |
| Difference | +31 | +25 | +16 | +7 | −2 | +32 | +20 | +12 | +5 | −3 |
| from target | | | | | | | | | | |
| refractive index | | | | | | | | | | |
| n (×10⁻⁵) | | | | | | | | | | |
| | | | | | Implementation | | | | | Implementation |

| | Kind of glass | | | | | | | | | |
|---|---|---|---|---|---|---|---|---|---|---|
| | LaK13 | | | | | Lead-free SF | | | | |
| | Composition | | | | | | | | | |
| | m = 8 | | | | | m = 14 | | | | |
| Cooling rate | 70 | 80 | 90 | 100 | 110 | 70 | 80 | 90 | 100 | 110 |
| (° C./min) | | | | | | | | | | |
| Refractive index of | 1.69390 | 1.69381 | 1.69373 | 1.69368 | 1.69359 | 1.83920 | 1.83907 | 1.83897 | 1.83889 | 1.83880 |
| molded article | | | | | | | | | | |
| Difference | +40 | +31 | +23 | +18 | +9 | +3 | −10 | −20 | −28 | −37 |
| from target | | | | | | | | | | |
| refractive index | | | | | | | | | | |
| n (×10⁻⁵) | | | | | | | | | | |
| | | | | | Implementation | Implementation | | | | |

### <Selection of Implementation Molding Condition>

Based on Table 7, a molding condition (cooling rate) wherein the measured refractive index value is closest to the target refractive index was selected in each Example. As a result, the implementation composition was m=6 of SK12 and the cooling rate was 110° C./minute in Example 1, the implementation composition was m=10 of LaSFO3 and the cooling rate was 110° C./minute in Example 2, the implementation composition was m=8 of LaK13 and the cooling rate was 110° C./minute in Example 3, and the implementation composition was m=14 of lead-free SF and the cooling rate was 70° C./minute in Example 4. In the selected four samples, the difference d from the target refractive index was 2×10⁻⁵ to 9×10⁻⁵.

In each Example, a time for determining the above composition and molding condition was 30.5 hours.

### Example 5

With regard to a lens having a designed shape wherein a required tolerance of refractive index was ±80×10⁻⁵ which was somewhat larger than usual one, 14 kinds of the candidate compositions the same as in Example 1 were selected and glass samples thereof were prepared. When the refractive index thereof after press molding was measured and four kinds were selected as implementation compositions in the order of closeness to the target refractive index, the difference d from the target refractive index was −13×10⁻⁵ to 25×10⁻⁵. The results sufficiently satisfied the tolerance even when unevenness induced by the difference in molded shape and size between the samples and true molded articles was considered.

The time required for the above composition determination was 18 hours.

While the invention has been described in detail and with reference to specific embodiments thereof, it will be apparent to one skilled in the art that various changes and modifications can be made therein without departing from the spirit and scope thereof.

The present application is based on Japanese Patent Application No. 2007-057498 filed on Mar. 7, 2007, and the contents thereof are incorporated herein by reference.

### INDUSTRIAL APPLICABILITY

A glass composition and a molding condition which afford an appropriate value as a refractive index of an optical glass product obtained by direct press molding without any annealing treatment, can be set conveniently for a short period of time and a desired optical glass element can be efficiently produced and provided according to design change of a product.

1. A method for producing an optical glass element showing a desired refractive index by press molding without any annealing treatment, which comprises:
a step of regarding the desired refractive index as a target refractive index, determining as a basic composition a glass composition showing the target refractive index when subjected to an annealing treatment after press molding, changing a component ratio of the basic composition with defining as a predetermined range a range where values of the target refractive index+(100 to 850)×10⁻⁵ are upper and lower limits, and providing as candidate compositions a plurality of glass compositions whose estimated refractive index values estimated based on a variation in composition from the basic composition are regularly changed within the predetermined range,
a step of preparing glasses having the candidate compositions and subjecting them to press molding under a predetermined molding condition to obtain glass molded articles having the candidate compositions,
a step of measuring the refractive indices of the glass molded articles having the candidate compositions and determining the candidate composition of the glass molded article having a measured refractive index value coincident with or closest to the target refractive index as an implementation composition,
a step of, in the case where the measured refractive index value of the glass molded article having the implementation composition is coincident with the target refractive index, determining the predetermined molding condition as an implementation molding condition; in the case where the measured refractive index value of the glass molded article having the implementation composition is not coincident with the target refractive index, subjecting the glass having the implementation composition to press molding under each of a plurality of molding conditions regularly changed from the predetermined molding condition to obtain glass molded articles having an implementation composition under the plurality of molding conditions, measuring the refractive indices of the glass molded articles, and determining a molding condition of the glass molded article having a measured refractive index value coincident with or closest to the target refractive index as an implementation condition, and
a step of preparing a glass having the implementation composition and subjecting it to press molding under the implementation molding condition to obtain a glass molded article.

2. The method for producing an optical glass element according to claim 1, wherein the variation in composition from the basic composition in the large number of compositions is set so that mutual interval in the estimated refractive index values estimated based on the variation in composition is a constant value of 100×10⁻⁵ or less.

3. The method for producing an optical glass element according to claim 1, wherein the variation in composition is provided by a replacement amount at which one component is replaced with another component among two or more components constituting the basic composition, and the estimated refractive index value is calculated using the basic refractive index and the replacement amount based on additivity relationship of glass.

4. The method for producing an optical glass element according to claim 3, wherein the replacement amount is set so that the estimated refractive index values in the candidate compositions change from the value of the basic refractive index+100×10⁻⁵ to the value of the basic refractive index+850×10⁻⁵ at intervals of 50×10⁻⁵.

5. The method for producing an optical glass element according to claim 1, wherein the variation in condition regularly changed from the predetermined molding condition is a change in cooling rate after press molding, and the cooling rate is changed at intervals of 20° C./minute or less.
